(19) United States
(12) Patent Application Publication
(10) Pub. No.: US 2014/0065947 A1
(43) Pub. Date: Mar. 6, 2014

(54) ELECTRONIC APPARATUS, NON-TRANSITORY COMPUTER READABLE MEDIUM, AND PROCESSING METHOD

(71) Applicant: Kabushiki Kaisha Toshiba, Tokyo (JP)

(72) Inventor: Naoki ESAKA, Tachikawa-shi (JP)

(73) Assignee: Kabushiki Kaisha Toshiba, Tokyo (JP)

(21) Appl. No.: 13/973,667

(22) Filed: Aug. 22, 2013

Related U.S. Application Data
(63) Continuation of application No. PCT/JP2013/057931, filed on Mar. 13, 2013.

(30) Foreign Application Priority Data
Aug. 28, 2012 (JP) 2012-187372

(51) Int. Cl. H04H 20/86

(52) U.S. Cl. CPC H04H 20/86
USPC 455/3.06

(57) ABSTRACT

According to one embodiment, a broadcast receiver acquires first position data from information relating (ZIP code) of the receiver by referring to information managed in a server, and acquires second position second position data of a neighboring area, and finally acquires broadcasting service lists from these position data by referring to information managed in the server.

### CROSS REFERENCE TO RELATED APPLICATIONS

This application is a Continuation Application of PCT Application No. PCT/JP2013/057931, filed Mar. 13, 2013 and based upon and claiming the benefit of priority from Japanese Patent Application No. 2012-187372, filed Aug. 28, 2012, the entire contents of all of which are incorporated herein by reference.

### FIELD

Embodiments described herein relate generally to an electronic apparatus, a non-transitory computer readable medium and a processing method.

### BACKGROUND

Broadcasting services which are receivable by electronic apparatuses vary according to area, for instance, country and region. The user inputs a Zone Improvement Plan (ZIP) code or the name of the locality (such as the district, province, prefecture, or city) assigned to each area by the electronic apparatus, and can thereby be cognizant of which broadcasting services can be received. Specifically, the electronic apparatus acquires information on the broadcasting services corresponding to the input ZIP code or name of the locality, with reference to a database which manages ZIP codes or names of localities in correlation with the broadcasting services.

When the electronic apparatus exists in an area extending into neighboring countries or regions, however, there are cases where broadcasting services which are receivable by the electronic apparatus actually exist beyond the country or region, these being broadcasting services other than those corresponding to the ZIP code or names of localities defining the area and managed by the database. Therefore, the electronic apparatus cannot show the user that there are broadcasting services which can actually be received but are not managed by the database.

Therefore, to be cognizant of the broadcasting services necessary for an electronic apparatus located in an area, the user has to input not only the ZIP code or name of locality defining the area in which the electronic apparatus is located at present but also, one by one, neighboring ZIP codes or names of localities in order to check which broadcasting services can be received.

In addition, ZIP codes are assigned to not only geographic areas, but also special purposes. ZIP codes are assigned to organizations such as companies and schools, as special purposes. In the present specification, such ZIP codes are referred to as special ZIP codes. Even when special ZIP codes are input, the electronic apparatus cannot present receivable broadcasting services to the user, even with reference to the database.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram of constituent elements according to an embodiment.

FIG. 2 is an exemplary flowchart illustrating processing for acquiring broadcasting service information according to the embodiment.

FIG. 3 is an exemplary schematic diagram of a neighboring area according to the embodiment.

### DETAILED DESCRIPTION

Various embodiments will be described hereinafter with reference to the accompanying drawings.

In general, according to one embodiment, an electronic apparatus includes an input unit, and a processor. The input unit is configured to input first information relating to a geographic position of the electronic apparatus. The processor is configured to acquire second information of a first position based on the first information, third information of one or more second position from a neighboring area of the first position, and fourth information of receivable broadcasting services at the first position or the second positions by using the second information and the third information.

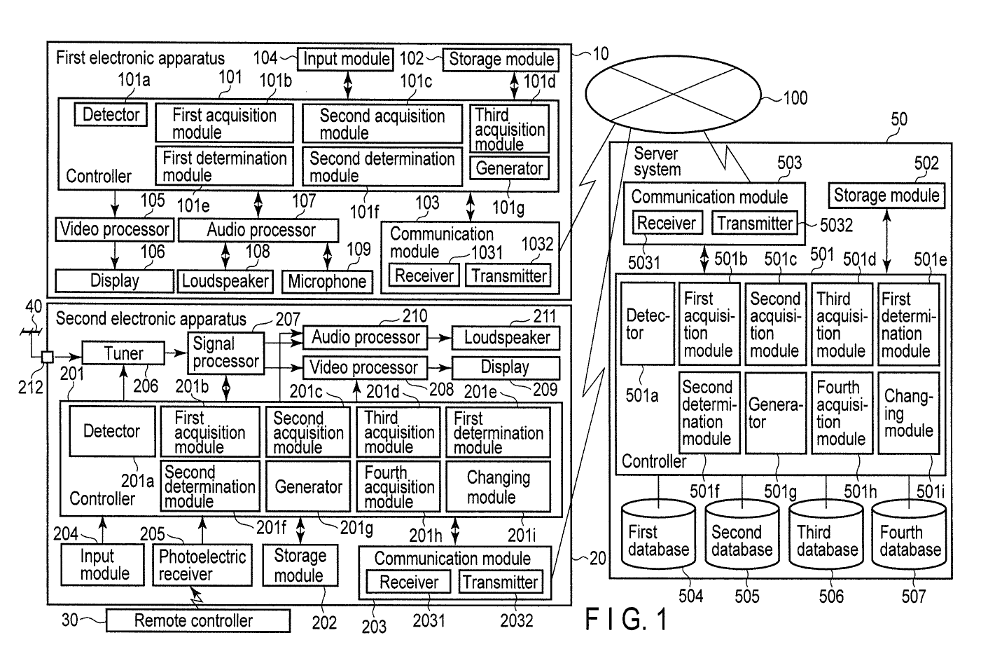

An embodiment will be explained hereinafter with reference to drawings. FIG. 1 is a block diagram illustrating an outline of an example of a first electronic apparatus 10, a second electronic apparatus 20, and a server system 50 according to the embodiment.

A configuration of the first electronic apparatus 10 will be explained hereinafter. The first electronic apparatus 10 is an electronic apparatus which can access the server system 50 over a network 100. The first electronic apparatus 10 includes no tuner. The first electronic apparatus 10 is a portable terminal such as a smartphone or a tablet computer, but is not limited to them.

The first electronic apparatus 10 comprises a controller 101, a storage module 102, a communication module 103, an input unit 104, a video processor 105, a display 106, an audio processor 107, a loudspeaker 108, and a microphone 109.

The controller 101 controls operation of the elements in the first electronic apparatus 10. The controller 101 includes various modules (functions). The controller 101 includes, for example, a detector 101a, a first acquisition module 101b, a second acquisition module 101c, a third acquisition module 101d, a first determination module 101e, a second determination module 101f, and a generator 101g.

The storage module 102 includes a memory capable of writing, reading, and rewriting various information items. The storage module 102 includes a memory which stores a program configured to achieve functions executed by the controller 101. The storage module 102 also includes a memory which provides the controller 101 with a work area.

The communication module 103 is an interface configured to communicate with the server system 50 through the network 100. The communication module 103 includes a receiver 1031 which receives information from the server system 50, and a transmitter 1032 which transmits information to the server system 50.

The input unit 104 is an interface (input unit) configured to input user operations. The input unit 104 is, for example, a keypad or touch sensor provided integrally with the display 106. The input unit 104 supplies an operation signal generated according to user operation to the controller 101. User operations performed on the input unit 104 are reflected on the elements in the first electronic apparatus 10 by the controller 101.

The video processor 105 converts a video signal which is based on various kinds of content or application-originated output into a video signal of a format which can be displayed on the display 106. The video processor 105 outputs the video signal to the display 106.

The display 106 displays a moving picture based on the video signal.

The audio processor 107 converts an audio signal which is based on various kinds of content or application-originated output into an audio signal of a format which can be played back by the loudspeaker 108. The audio processor 107 outputs the audio signal to the loudspeaker 108. The audio processor 107 also converts sound picked up by the microphone 109 into a digital audio signal, and outputs the signal to the controller 101.

The loudspeaker 108 outputs sound based on the audio signal.

The microphone 109 picks up sound produced outside the first electronic apparatus 10, such as the user's voice produced during a call.

A configuration of the second electronic apparatus 20 will be explained hereinafter. The second electronic apparatus 20 is an electronic apparatus which can access the server system 50 over the network 100. The second electronic apparatus 20 includes a tuner. The second electronic apparatus 20 is, for example, a digital television or an HDD recorder, but is not limited to these. The second electronic apparatus 20 may be a portable terminal such as a smartphone or tablet computer having a built-in tuner. In the case of the second electronic apparatus 20, the tuner may take the form of a separate component such as a set-top box.

The second electronic apparatus 20 comprises a controller 201, a storage module 202, a communication module 203, an input unit 204, a photoelectric receiver 205, a tuner 206, a signal processor 207, a video processor 208, a display 209, an audio processor 210, and a loudspeaker 211.

The controller 201 controls operations of the elements in the second electronic apparatus 20. The controller 201 includes various modules (functions) as described later. The controller 201 includes, for example, a detector 201a, a first acquisition module 201b, a second acquisition module 201c, a third acquisition module 201d, a first determination module 201e, a second determination module 201f, a generator 201g, a fourth acquisition module 201h, and a changing module 201i. The detector 201a, the first acquisition module 201b, the second acquisition module 201c, the third acquisition module 201d, the first determination module 201e, the second determination module 201f, and the generator 201g may operate in the same manner as the detector 101a, the first acquisition module 101b, the second acquisition module 101c, the third acquisition module 101d, the first determination module 101e, the second determination module 101f, and the generator 101g, respectively.

The storage module 202 includes a memory which allows the writing, reading, and rewriting of various items of information. The storage module 202 includes a memory which stores a program configured to realize the functions executed by the controller 201. The storage module 202 also includes a memory which provides the controller 201 with a work area.

The communication module 203 is an interface configured to communicate with the server system 50 through the network 100. The communication module 203 includes a receiver 2031 which receives information from the server system 50, and a transmitter 2032 which transmits information to the server system 50.

The input unit 204 is an interface (input unit) configured to input user operations. The input unit 204 is, for example, a keypad. The input unit 204 supplies an operation signal generated according to user operation to the controller 201. User operations performed on the input unit 204 are reflected on the elements in the second electronic apparatus 20 by the controller 201.

The photoelectric receiver 205 is an input module to which a signal representing a user operation performed by means of a remote controller 30 is input. The photoelectric receiver 205 outputs an operation signal generated according to user operation to the controller 201. The user operations communicated to the photoelectric receiver 205 are reflected on the elements in the second electronic apparatus 20 by the controller 201.

The tuner 206 receives a broadcast signal received by an antenna 40 through an input terminal 212. The tuner 206 receives channel information, which will be described later, via the broadcast signal. The tuner 206 outputs the selected broadcast signal to the signal processor 207.

The signal processor 207 demodulates the broadcast signal into a digital video signal and digital audio signal. In addition, the signal processor 207 performs predetermined digital signal processing on the video signal and the audio signal, and outputs the video signal and the audio signal to the video processor 208 and the audio processor 210, respectively.

The video processor 208 converts a video signal based on various kinds of content or application-originated output into a video signal of a format which can be displayed on the display 209. The video processor 208 outputs the video signal to the display 209.

The display 209 displays a moving picture based on the video signal.

The audio processor 210 converts an audio signal which is based on various kinds of content or application-originated output into an audio signal of a format which can be played back by the loudspeaker 211. The audio processor 210 outputs the audio signal to the loudspeaker 211.

The loudspeaker 211 outputs sound based on the audio signal.

A configuration of the server system 50 will be explained hereinafter. The server system 50 can be connected to the electronic apparatuses through the network 100.

The server system 50 comprises a controller 501, a storage module 502, a communication module 503, a first database 504, a second database 505, a third database 506, and a fourth database 507.

The controller 501 controls operations of the elements in the server system 50. The controller 501 includes various modules (functions) as described later. The controller 501 includes, for example, a detector 501a, a first acquisition module 501b, a second acquisition module 501c, a third acquisition module 501d, a first determination module 501e, a second determination module 501f, a generator 501g, a fourth acquisition module 501h, and a changing module 501i. The detector 501a, the first acquisition module 501b, the second acquisition module 501c, the third acquisition module 501d, the first determination module 501e, the second determination module 501f, the generator 501g, the fourth acquisition module 501h, and the changing module 501i may operate in the same manner as the detector 101a, the first acquisition module 101b, the second acquisition module 101c, the third module 101d, the first determination module 101e, the second determination module 101f, the generator 101g, the fourth acquisition module 201h, and the changing module 201i, respectively.

The storage module 502 includes a memory which allows the writing, reading, and rewriting of various items of information. The storage module 502 includes a memory which stores a program configured to realize the functions executed by the controller 501. The storage module 502 also includes a memory which provides the controller 501 with a work area.

The communication module 503 is an interface configured to communicate with the electronic apparatuses through the network 100. The communication module 503 includes a receiver 5031 which receives information from the electronic apparatuses, and a transmitter 5032 which transmits information to the electronic apparatuses.

The first database 504 manages information obtained by associating ZIP codes assigned to respective areas with information of receivable broadcasting services. The broadcasting services are not limited to services distributed by means of broadcast signals, but may include services distributed by cable television providers. The information of receivable broadcasting services managed by the first database 504 is information on broadcasting services the electronic apparatuses can receive in respective areas, to which ZIP codes are assigned. The first database 504 may manage information which associates ZIP codes, to which country codes are added, with broadcasting services. This is because provided services vary between countries. Although country codes are not necessarily used in the present embodiment, a code including at least a ZIP code is referred to as a “country/ZIP code”.

The second database 505 manages information obtained by associating the country/ZIP codes assigned to the respective areas with positional information items. In the present embodiment, a positional information item is, for example, information including at least a geographic position defined in terms of latitude and longitude. In the present specification, although the positional information may be referred to as “information of position”, they indicate the same element.

The third database 506 manages information obtained by associating special ZIP codes with addresses. The addresses managed by the third database 506 are, for example, postal delivery addresses of the delivery destinations held by the post offices, but are not limited to these.

The fourth database 507 manages information obtained by associating the addresses managed by the third database 506 with the positional information items.

The server system 50 is not limited to a mode of one device as illustrated in FIG. 1. The server system 50 may have a structure in which at least one of the constituent elements of the server system 50 illustrated in FIG. 1 and the modules (functions) of the controller 501 is separated as a separate element.

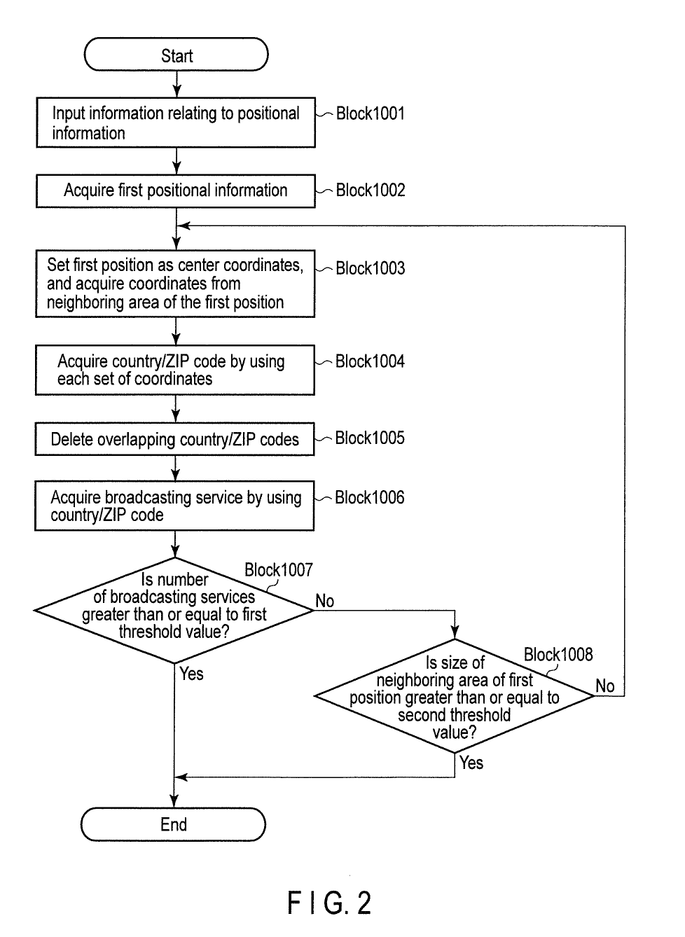

Next, the processing of acquiring information on the broadcasting services which can be received by the electronic apparatus according to the present embodiment will be explained hereinafter, by using the flowchart of FIG. 2. Although the first electronic apparatus 10 is explained hereinafter as an example, the same is applicable to the second electronic apparatus 20, and thus explanation thereof is omitted.

First, the controller 101 (detector 101a) detects the input of information relating to positional information of the first electronic apparatus 10 (Block 1001). In Block 1001, by means of user operation, information relating to positional information of the first electronic apparatus 10 is input to the input unit 104. For example, by means of user operation, a country/ZIP code may be input to the input unit 104 by the user as the information relating to the positional information. In this case, the controller 101 (detector 101a) detects input of the country/ZIP code by the user.

The controller 101 (first acquisition module 101b) refers to the information managed by the second database 505, and acquires first positional information defined in terms of at least latitude and longitude, based on the information relating to the positional information (Block 1002). In Block 1002, the controller 101 converts, for example, the country/ZIP code into positional information.

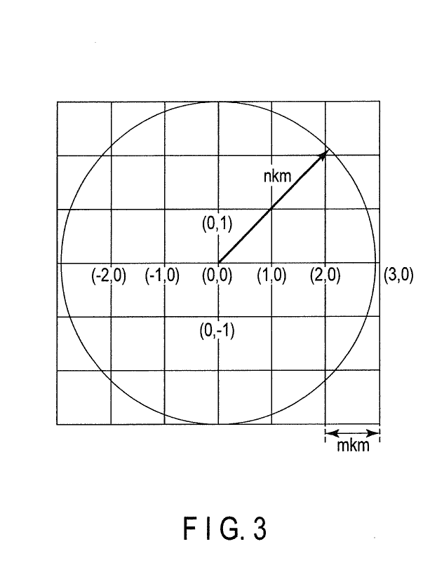

The controller 101 (second acquisition module 101c) sets the first position as a center coordinate, sets a neighboring area of the first position, and extracts and acquires one or more sets of coordinates (second positional information defined in terms of at least latitude and longitude) from the neighboring area of the first position (Block 1003). The neighboring area may have any shape, as long as it includes the first position. In Block 1003, the controller 101 sets, for example, an area having a radius of n km as illustrated in FIG. 3, which is a neighboring area of the center coordinate, and extracts coordinates of each divided area acquired by dividing the neighboring area for every m km in a lattice manner. The controller 101 may extract coordinates by dividing the neighboring area into other shapes, and the method of extracting the coordinates is not limited.

The controller 101 (third acquisition module 101d) acquires the country/ZIP code by using each set of coordinates, with reference to the information managed by the second database 505 (Block 1004). In Block B1004, the controller 101 acquires country/ZIP codes corresponding to the first positional information and the second positional information by using the first positional information and the second positional information.

The controller 101 deletes overlapping country/ZIP codes among those acquired in Block 1004 (Block 1005).

The controller 101 (third acquisition module 101d) acquires information items on broadcasting services which the first electronic apparatus 10 can receive by using the country/ZIP codes corresponding to the first positional information and the second positional information, with reference to the information managed by the first database 504 (Block 1006). Specifically, according to the processing performed in Block 1004 and Block 1006, the controller 101 can acquire broadcasting services which can be received at the first position or the second position by using the first positional information and the second positional information, with reference to the information managed by the first database 504 and the information managed by the second database 505. The controller 101 may store information on broadcasting services, which is acquired by deleting the overlapping broadcasting services among the broadcasting services acquired in Block 1006, in the storage module 102.

The controller 101 (first determination module 101e) determines whether the number of broadcasting services, which can be received at the first position or the second position and have been acquired in Block 1006, is greater than or equal to a first threshold value (Block 1007).

When the controller 101 determines that the number of receivable broadcasting services is greater than or equal to the first threshold value (Block 1007, Yes), the controller 101 (generator 101g) generates a list of the broadcasting services acquired in Block 1006. Thereafter, the controller 101 performs control to display the list of broadcasting services on the display 106. The order of the broadcasting services displayed in the list to be presented to the user is not limited.

When the determination module 101 determines that the number of receivable broadcasting services is less than the first threshold value (Block 1007, No), the controller 101 (second determination module 101f) determines whether the size of the neighboring area of the first position set in Block 1003 is greater than or equal to a second threshold value or not (that is, whether the area has been extended from the first position to a range of a certain distance) (Block 1008). When the controller 101 determines that the size of the neighboring area of the first position is greater than or equal to the second threshold value (Block 1008, Yes), the controller 101 generates a list of the broadcasting services acquired in Block 1006.

When the controller 101 determines that the size of the neighboring area of the first position is less than the second threshold value (Block 1008, Yes), the controller 101 returns to Block 1003, extends the neighboring area of the first position set in Block 1003, and acquires the second positional information. Specifically, in Block 1003, the controller 101 gradually extends the area from the first position, and, step by step, acquires second positional information of the second position, which is located distant from the first position.

In Block 1001, the controller 101 may detect input of information relating to positional information other than the country/ZIP code. For example, the controller 101 may detect input of positional information which is based on GPS or WiFi and defined in terms of at least latitude and longitude, or input of positional information which is generated by tapping on a map application display and defined in terms of at least latitude and longitude. In this case, in Block 1002, the controller 101 may acquire the first positional information directly from the user input, without referring to the information managed by the second database 505.

In Block 1001, for example, a special ZIP code may be input to the input unit 104, by means of user operation, as the information relating to the positional information. In this case, the controller 101 detects input of a special ZIP code as input of the information relating to the positional information. In this case, in Block 1002, the controller 101 may acquire the first positional information, by acquiring an address by using the special ZIP code with reference to the information managed by the third database 506, and by acquiring the first positional information by using the address with reference to the information managed by the fourth database 506.

Although the above explanation shows an example of acquiring the information on broadcasting services by processing performed in the first electronic apparatus 10 or the second electronic apparatus 20, the information on the broadcasting services may be acquired by processing performed in the server system 50. In this case, in Block 1001, the controller 501 can detect input of the information relating to the positional information by, for example, receiving the information relating to the positional information, which has been input to the first electronic apparatus 10 or the second electronic apparatus 20, by the receiver 1031 from the first electronic apparatus 10 or the second electronic apparatus 20, which is an external device. In Block 1002 to Block 1008, the controller 501 can perform processing in the same manner as the controller 101, as explained above. When the controller 501 determines in Block 1007 that the number of receivable broadcasting services is greater than or equal to the first threshold value (Block 1007, Yes) or determines in Block 1008 that the size of the neighboring area of the first position is greater than or equal to the second threshold value (Block 1008, Yes), the controller 501 can send back the list of the broadcasting services to the first electronic apparatus 10 or the second electronic apparatus 20 through the transmitter 1032.

According to the present embodiment, the user can acquire information on necessary broadcasting services, by inputting information relating to the positional information once. In addition, the user can also, without effort, acquire information on broadcasting services provided in neighboring countries and regions. Therefore, broadcasting services are hardly omitted from user's choices, and the usability increases.

As another embodiment, in the second electronic apparatus 20, when the controller 201 (third acquisition module 201h) can acquire channel information carried by broadcast signals and relates to the receivable broadcasting services, the controller 201 (changing module 201i) may delete information on broadcasting services which do not correspond to the channel information, from the information on broadcasting services receivable at the first position and the second position, which is acquired by the processing of the flowchart illustrated in FIG. 2. When the server system 50 performs processing in accordance with the flowchart illustrated in FIG. 2, the controller 201 may transmit channel information to the server system 50 through the transmitter 3032.

According to the above embodiment, the user can acquire information on broadcasting services which can be more securely received in the position where the electronic apparatus is located.

The following is explanation of the channel information.

First, channel information according to the European standard will be explained.

When the controller 201 acquires channel information according to the European standard, the controller 201 acquires triplet information (original network ID, transport stream ID, and service ID) of the Digital Video Broadcasting (DVB) standard and information (DVB-T, . . . ) for identifying the network type of DVB, and the code for identifying the country (GB, DE, . . . ), as the channel information. When another standard is used for a specialty channel, the controller 201 should use an ID defined for the system.

The above elements are indicated by the following values: for example, the original network ID is indicated by a numerical value, the transport stream ID is indicated by a numerical value, the service ID is indicated by a numerical value, the information for identifying the DVB network type is indicated by VB-C, DVB-S, DVB-T, DVB-C2, DVB-S2, or DVB-T2, and the code for identifying the country is indicated by GB, DE, CH, . . . (based on ISO 3166-1, alpha-2). The channel information is expressed as, for example, (channel1, 1, 1026, 10050, DVB-S, GB), (channel2, 2, 2045, 6301, DVB-T2, CH), or (channel3, 9018, 4169, 4168, DVB-S2, ES).

Next, channel information according to the Japanese standard will be explained.

When the controller 201 acquires channel information according to the Japanese standard, the controller 201 acquires the network ID, the transport stream ID, the service ID of the Integrated Services Digital Broadcasting (ISDB) standard, the code for identifying the broadcast type, and the code for identifying the country, as the channel information. When another standard is used for a specialty channel, the controller 201 should use an ID defined for the system.

The above elements are indicated by the following values: for example, the network ID is indicated by a numerical value, the transport stream ID is indicated by a numerical value, the service ID is indicated by a numerical value, the code for identifying the broadcast type is indicated by ISDB-T, ISDB-C, ISDB-S, or e2skyperfectv, etc., and the code for identifying the country is indicated by JP (fixed). The channel information is expressed as, for example, (channel1, 7d71, 7d71, 50, ISDB-T, JP), (channel2, 0004, 10, 6301, ISDB-B, JP), or (channel3, 0006, 110, 4168, e2skyperfectv, JP).

In the case of terrestrial digital broadcasting (ISDB-T) in Japan, broadcast signals are transmitted for each broadcast station, and thus the network ID agrees with the transport stream ID.

Although the channel information can be formed without the transport stream ID itself in the Japanese standard, the transport stream ID exists in the standard, and is included in the channel information for future compatibility.

The controller 201 may acquire information as to what channel is assigned to the number (1-12) of the remote controller, as the channel information. In the case of acquiring the above information, the controller 201 adds information such as 1 (for key #1) to each channel information item.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an input unit configured to input first information relating to a geographic position of the electronic apparatus; and
a processor configured to acquire second information of a first position based on the first information,
to acquire third information of one or more second position from a neighboring area of the first position, and
to acquire fourth information of receivable broadcasting services at the first position or the second positions by using the second information and the third information.

2. The apparatus of claim 1, wherein
the processor is further configured to acquire codes corresponding to the second information and the third information by using the second information and the third information, with reference to information which associates codes that are assigned to respective areas with geographic positional information, and
to acquire the fourth information by using the codes corresponding to the second information and the third information, with reference to information which associates codes assigned to respective areas with receivable broadcasting services in respective areas.

3. The apparatus of claim 1, wherein
each of the second information and the third information is defined in terms of at least latitude and longitude.

4. The apparatus of claim 1, wherein the processor is configured to determine by a first determination, whether the receivable broadcasting services at the first position or the second positions are greater than or equal to a first threshold value in number.

5. The apparatus of claim 4, wherein the processor is further configured to generate a list of the receivable broadcasting services at the first position or the second positions, when the first determination determines that the receivable broadcasting services at the first position or the second positions are greater than or equal to the first threshold value in number.

6. The apparatus of claim 4, wherein the processor is further configured to determine by a second determination, whether a size of a neighboring area of the first position is greater than or equal to a second threshold value or not, when the first determination determines that the receivable broadcasting services at the first position or the second positions are less than the first threshold value in number.

7. The apparatus of claim 6, wherein
the processor is configured to extend a neighboring area of the first position and acquire third information of second positions, when the second determination determines that a size of a neighboring area of the first position is less than the second threshold value.

8. The apparatus of claim 1, wherein the processor is further configured to acquire channel information which is carried by broadcast signals; and
to delete broadcasting services, which do not correspond to the channel information, from the receivable broadcasting services at the first position or the second positions.

9. A non-transitory computer readable medium having stored thereon a computer program which is executable by a computer, the computer program controlling the computer to execute functions of:
receiving first information relating to a geographic position of an electronic apparatus;
acquiring second information of a first position based on the first information;
acquiring third information of one or more second positions from a neighboring area of the first position; and
acquiring fourth information of receivable broadcasting services at the first position or the second positions by using the second information and the third information.

10. The non-transitory computer readable medium of claim 9, wherein the computer program controls the computer to execute functions of:
acquiring codes corresponding to the second information and the third information by using the second information and the third information, with reference to information which associates codes that are assigned to respective areas with geographic positional information, and
acquiring the fourth information by using the codes corresponding to the second information and the third information, with reference to information which associates codes assigned to respective areas with receivable broadcasting services in respective areas.

11. The non-transitory computer readable medium of claim 9, wherein
each of the second information and the third information is defined in terms of at least latitude and longitude.

12. The non-transitory computer readable medium of claim 9, wherein the computer program controls the computer to execute functions of:
determining by a first determination, whether the receivable broadcasting services at the first position or the second positions are greater than or equal to a first threshold value in number.

13. The non-transitory computer readable medium of claim 12, wherein the computer program controls the computer to execute functions of:
generating a list of the receivable broadcasting services at the first position or the second positions, when the first determination determines that the receivable broadcasting services at the first position or the second positions are greater than or equal to the first threshold value in number.

14. The non-transitory computer readable medium of claim 12, wherein the computer program controls the computer to execute functions of:
determining by a second determination, whether a size of a neighboring area of the first position is greater than or equal to a second threshold value or not, when the first determination determines that the receivable broadcasting services at the first position or the second positions are less than the first threshold value in number.

15. The non-transitory computer readable medium of claim 14, wherein the computer program controls the computer to execute functions of:
extending a neighboring area of the first position and acquire third information of second positions, when the second determination determines that a size of a neighboring area of the first position is less than the second threshold value.

16. The non-transitory computer readable medium of claim 9, wherein the computer program controls the computer to execute functions of:
acquiring channel information which is carried by broadcast signals; and
deleting broadcasting services, which do not correspond to the channel information, from the receivable broadcasting services at the first position or the second positions.

17. A processing method comprising:
receiving first information relating to a geographic position of an external device from the external device;
acquiring second information of a first position based on the first information,
acquiring third information of one or more second position from a neighboring area of the first position, and
acquiring fourth information of receivable broadcasting services at the first position or the second positions by using the second information and the third information.

18. The processing method of claim 17, further comprising:
acquiring codes corresponding to the second information and the third information by using the second information and the third information, with reference to information which associates codes that are assigned to respective areas with geographic positional information, and
acquiring the fourth information by using the codes corresponding to the second information and the third information, with reference to information which associates codes assigned to respective areas with receivable broadcasting services in respective areas.

19. The processing method of claim 17, wherein
each of the second information and the third information is defined in terms of at least latitude and longitude.

20. The processing method of claim 17, further comprising:
determining by a first determination, whether the receivable broadcasting services at the first position or the second positions are greater than or equal to a first threshold value in number.

21. The processing method of claim 20, further comprising:
generating a list of the receivable broadcasting services at the first position or the second positions, when the first determination determines that the receivable broadcasting services at the first position or the second positions are greater than or equal to the first threshold value in number.

22. The processing method of claim 20, further comprising:
determining by a second determination, whether a size of a neighboring area of the first position is greater than or equal to a second threshold value or not, when the first determination determines that the receivable broadcasting services at the first position or the second positions are less than the first threshold value in number.

23. The processing method of claim 22, further comprising:
extending a neighboring area of the first position and acquire third information of second positions, when the second determination determines that a size of a neighboring area of the first position is less than the second threshold value.

24. The processing method of claim 17, further comprising:
acquiring channel information which is carried by broadcast signals; and
deleting broadcasting services, which do not correspond to the channel information, from the receivable broadcasting services at the first position or the second positions.
